(19) United States
(12) Patent Application Publication
(10) Pub. No.: US 2026/0164225 A1
(43) Pub. Date: Jun. 11, 2026

(54) EXTENSION OF USER EQUIPMENT HISTORY INFORMATION

(71) Applicant: Telefonaktiebolaget LM Ericsson (publ), Stockholm (SE)

(72) Inventors: Luca LUNARDI, Genoa (IT); Angelo CENTONZA, Granada (ES); Julien MULLER, Rennes (FR); Germán BASSI, Årsta (SE); Ionna PAPPA, Stockholm (SE)

(73) Assignee: Telefonaktiebolaget LM Ericsson (publ), Stockholm (SE)

(21) Appl. No.: 19/114,263

(22) PCT Filed: Sep. 26, 2023
(86) PCT No.: PCT/SE2023/050938

§ 371 Date: Mar. 21, 2025

(30) Foreign Application Priority Data
Sep. 27, 2022 (GR) 20220100788

(51) Int. Cl. H04W 8/08

(52) U.S. Cl. CPC H04W 8/08

(57) ABSTRACT

According to some embodiments, a method is performed by a network node. The method comprises deriving a mobility prediction report for a wireless device and transmitting the mobility prediction report to another network node. In some embodiments, the mobility prediction report comprises an indication of one or more cells or synchronization signal block (SSB) beams that the wireless device is predicted to traverse.

### TECHNICAL FIELD

Embodiments of the present disclosure are directed to wireless communications and, more particularly, to extensions of user equipment (UE) history information.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

The next generation radio access network (NG-RAN) consists of a set of gNBs connected to the fifth generation core (5GC) through the NG interface. An example is illustrated in FIG. 1.

FIG. 1 is a block diagram illustrating the NG-RAN architecture, as described in Third Generation Partnership Project (3GPP) TS 38.401 v17.1.0. As specified in 3GPP TS 38.300 v17.1.0, NG-RAN may also consist of a set of ng-eNBs, an ng-eNB may consist of an ng-eNB central unit (CU) and one or more ng-eNB distributed units (DU(s)). An ng-eNB-CU and an ng-eNB-DU are connected via the W1 interface. The general principle described herein also applies to ng-eNB and the W1 interface, if not explicitly specified otherwise.

A gNB can support frequency division duplex (FDD) mode, time division duplex (TDD) mode, or dual mode operation. The gNBs may be interconnected through the Xn interface. A gNB may consist of a gNB-CU and one or more gNB-DU(s). A gNB-CU and a gNB-DU are connected via the F1 interface. One gNB-DU is connected to only one gNB-CU.

For network sharing with multiple cell ID broadcast, each Cell Identity associated with a subset of public land mobile networks (PLMNs) corresponds to a gNB-DU and the gNB-CU it is connected to, i.e., the corresponding gNB-DUs share the same physical layer cell resources.

For resiliency, a gNB-DU may be connected to multiple gNB-CUs by appropriate implementation.

NG, Xn, and F1 are logical interfaces.

For NG-RAN, the NG and Xn-C interfaces for a gNB consisting of a gNB-CU and gNB-DUs, terminate in the gNB-CU. For EN-DC, the S1-U and X2-C interfaces for a gNB consisting of a gNB-CU and gNB-DUs, terminate in the gNB-CU. The gNB-CU and connected gNB-DUs are only visible to other gNBs and the 5GC as a gNB.

The node hosting the user plane part of New Radio (NR) Packet Data Convergence Protocol (PDCP) (e.g., gNB-CU, gNB-CU-UP, and for EN-DC, MeNB or SgNB depending on the bearer split) shall perform user inactivity monitoring and further inform its inactivity or (re) activation to the node having control-plane connection towards the core network (e.g., over E1, X2). The node hosting NR radio link control (RLC) (e.g., gNB-DU) may perform user inactivity monitoring and further inform its inactivity or (re) activation to the node hosting control plane, e.g., gNB-CU or gNB-CU-CP.

Uplink (UL) PDCP configuration (i.e., how the user equipment (UE) uses the UL at the assisting node) is indicated via X2-C (for EN-DC), Xn-C (for NG-RAN), and F1-C. Radio Link Outage/Resume for downlink (DL) and/or UL is indicated via X2-U (for EN-DC), Xn-U (for NG-RAN) and F1-U.

The NG-RAN is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1), the related TNL protocol and the functionality are specified. The TNL provides services for user plane transport and signalling transport.

In NG-Flex configuration, each NG-RAN node is connected to all access and mobility management functions (AMFs) of AMF Sets within an AMF Region supporting at least one slice also supported by the NG-RAN node. The AMF Set and the AMF Region are defined in 3GPP TS 23.501 v17.1.0.

If security protection for control plane and user plane data on TNL of NG-RAN interfaces is to be supported, NDS/IP 3GPP TS 33.501 v17.1.0 shall be applied.

The architecture for separation of gNB-CU-CP and gNB-CU-UP is depicted in FIG. 2 and specified in 3GPP TS 37.483 v17.1.0.

FIG. 2 is a block diagram illustrating the architecture for separation of gNB-CU-CP and gNB-CU-UP. A gNB may consist of a gNB-CU-CP, multiple gNB-CU-UPs and multiple gNB-DUs.

The gNB-CU-CP is connected to the gNB-DU through the F1-C interface. The gNB-CU-UP is connected to the gNB-DU through the F1-U interface. The gNB-CU-UP is connected to the gNB-CU-CP through the E1 interface. One gNB-DU is connected to only one gNB-CU-CP. One gNB-CU-UP is connected to only one gNB-CU-CP.

For resiliency, a gNB-DU and/or a gNB-CU-UP may be connected to multiple gNB-CU-CPs by appropriate implementation. One gNB-DU can be connected to multiple gNB-CU-UPs under the control of the same gNB-CU-CP. One gNB-CU-UP can be connected to multiple DUs under the control of the same gNB-CU-CP.

The connectivity between a gNB-CU-UP and a gNB-DU is established by the gNB-CU-CP using bearer context management functions. The gNB-CU-CP selects the appropriate gNB-CU-UP(s) for the requested services for the UE. For multiple gNB-CU-UPs they belong to same security domain as defined in 3GPP TS 33.210. Data forwarding between gNB-CU-UPs during intra-gNB-CU-CP handover within a gNB may be supported by Xn-U.

3GPP Release 16 includes UE history information. The network node collects information on cells visited by a UE in active mode and stores it as UE history information. The information is stored as a list pertaining to each cell in chronological order with the latest information at the top of the list. In the 3GPP standard, the list is capped at 16 entries (16 cells). The stated objective of UE history information is to prevent ping-pong. Ping-pong handover is an undesirable phenomenon in mobile networks, in which a UE performs frequent handovers between the same pair of cells back and forth, in a short time period.

The UE history information that is collected at a node is transferred to the target node during handover over the Xn interface. Similarly, the UE history information is sent to the core network (CN) over the NG interface during context release.

The data stored is dependent on the type of the connected cell as seen in the procedural text. For a NR cell, the network node collects the global cell ID, cell type, time UE stayed in cell, and the handover cause, and stores them for each UE upon cell change/handover.

The Information Element UE History Information from UE is defined in 3GPP TS 38.413 v17.1.0 and contains information about mobility history report for a UE. The content of the information element (IE) is shown below:

| | | | | |
|---|---|---|---|---|
| | | | IE type | |
| IE/Group | | | and | |
| Name | Presence | Range | reference | Semantics description |

| | | | |
|---|---|---|---|
| CHOICE UE | M | | |
| History | | | |
| Information | | | |
| from UE | | | |
| >NR | | | |
| >>NR | M | OCTET | VisitedCellInfoList |
| Mobility | | STRING | contained in the |
| History | | | UEInformationResponse |
| Report | | | message (TS 38.331 |
| | | | [18]). |

The referenced VisitedCellInfoList information element is specified in 3GPP TS 38.331 v17.1.0 as follows:

VisitedCellInfoList-r16 ::= SEQUENCE (SIZE (1..maxCellHistory-r16)) OF VisitedCellInfo-r16

| | |
|---|---|
| VisitedCellInfo-r16 ::= | SEQUENCE { |
| visitedCellId-r16 | CHOICE { |

| | |
|---|---|
| nr-CellId-r16 | CHOICE { |
| cgi-Info | CGI-Info-Logging-r16, |
| pci-arfcn-r16 | PCI-ARFCN-NR-r16 |

},

| | |
|---|---|
| eutra-CellId-r16 | CHOICE { |
| cellGlobalId-r16 | CGI-InfoEUTRA, |
| pci-arfon-r16 | PCI-ARFCN-EUTRA-r16 |

}

| | |
|---|---|
| } | OPTIONAL, |

| | |
|---|---|
| timeSpent-r16 | INTEGER (0..4095), |

```
  ...,
  [[
```

| | |
|---|---|
| visitedPSCellInfoList-r17 | VisitedPSCellInfoList-r17 OPTIONAL |

]]
}
VisitedPSCellInfoList-r17 ::= SEQUENCE (SIZE (1..maxPSCellHistory-r17)) OF VisitedPSCellInfo-
r17

| | |
|---|---|
| VisitedPSCellInfo-r17 ::= | SEQUENCE { |

| | |
|---|---|
| visitedCellId-r17 | CHOICE { |
| nr-CellId-r17 | CHOICE { |
| cgi-Info-r17 | CGI-Info-Logging-r16, |
| pci-arfcn-r17 | PCI-ARFCN-NR-r16 |

},

| | |
|---|---|
| eutra-CellId-r17 | CHOICE { |
| cellGlobalId-r17 | CGI-InfoEUTRALogging, |
| pci-arfcn-r17 | PCI-ARFCN-EUTRA-r16 |

}

| | |
|---|---|
| } | OPTIONAL, |

| | |
|---|---|
| timeSpent-r17 | INTEGER (0..4095), |

...
}

Release 17 work in UE history information has progressed to incorporate PSCell history information. The responsibility for collection of UE history information is split between the master node (MN) and the secondary node (SN). The MN is responsible for collection of PCell related information, and the SN is responsible for collecting PSCell related information. The MN obtains the information collected by the SN through subscription, querying, and/or SN release procedures. Finally, the MN correlates PSCell information from the SN with the collected PCell information. This correlated UE history information is then sent to the target MN during handover.

Information present in mobility history information (MHI) and UE history information (UHI) includes the following:
A list of previous PCells: UHI contain a list of previously visited PCells capped to a maximum of 16.
A list of previous PSCells: UHI contain a list of PSCells visited per PCell. This is capped at 8 per PCell for UHI.
Duration of stay in each cell: UHI contain the duration the UE stayed in each PCell and PSCell. This duration can be a maximum value of 4095 seconds (˜68 minutes). There is an additional IE that has a higher granularity.
Handover cause: UHI contains the cause of Handover (inter-MN). This is however not present in PSCell related UHI.
Cell type: UHI finally contains information about the type of cell enumerated as (verysmall, small, medium, large, . . . ).

WO2021028893A1 (Enhancements in Mobility History Information) describes methods for operating a UE comprising: receiving a request for UE mobility history information from a network node; generating a UE mobility history report; and transmitting the UE mobility history report to the network node, wherein the UE mobility history report comprises beam related information, sensor information, location information, and/or dual connectivity information for the UE.

Beam related information comprises: (a) a beam identifier of a beam monitored by the UE; (b) beam identifiers of all beams monitored for a single network transceiver node; (c) a beam identifier of a strongest beam monitored for a single network transceiver node; (d) timing information; and/or (e) a measurement time and/or discontinuous reception (DRX) related information.

The 3GPP Study Item (SI) “Study on enhancement for data collection for NR and EN-DC” studied general high-level principles, an artificial intelligence (AI)/machine learning (ML) functional framework, and the potential use cases, and the identified potential solutions for these use cases. The accomplishments of the study for AI enabled RAN are documented in 3GPP TR 37.817 v17.0.0. The normative work based on the conclusion of the Rel-17 SI is currently undertaken in 3GPP Rel-18, the related Work Item (WI) is described in RP-213602.

The functional framework for AI/ML in RAN captured in 3GPP TR 37.817 v17.0.0 is depicted in FIG. 3. The functional framework states that the Model Training function is a function that performs the AI/ML model training, validation, and testing and which may generate model performance metrics as part of the model testing procedure, whereas the Model Inference function is a function that provides AI/ML model inference output (e.g., predictions or decisions).

3GPP TR 37.817 v17.0.0, section 5.3.2.5, describes that AI/ML-based mobility optimization can generate as output, among other information, UE trajectory prediction (latitude, longitude, altitude, cell ID of UE over a future period of time).

The various participants in the normative work phase discussed whether there is a need to transfer the predicted UE trajectory over the Xn interface. Some participants believe the predicted trajectory information, together with other information, may help an NG-RAN node to select a more proper handover target cell. UE trajectory prediction is an important output for mobility optimization use case and may assist the target NG-RAN node to make further predictions of UE trajectory and UE handover decisions. Because the predicted UE trajectory may comprise locations or camp cells and the corresponding time interval, it can be later compared to the actual UE trajectory, for the purpose of performance evaluation of one AI/ML model.

The participants also discussed the feasibility of transferring the UE trajectory prediction, which depends on how the information is encoded. If the information is encoded as a prediction in terms of cells the UE will pass through, then the transfer may be reasonable. If the information is supposed to provide predicted geolocation of the UE in time, this becomes first complex, second sensitive, and third it imposes a requirement on the radio access network (RAN) to be able to geolocate the UE.

The participants also discussed that delivering the predicted trajectory during handover may be useful, e.g., beam-level prediction may be used for configuring target beams. Predicted UE trajectory may be transferred via the Xn interface to benefit the target NG-RAN node to perform subsequent network optimization. The definition of the predicted UE trajectory may include UE serving cells which will be resided in, or the predicted UE geographic location.

Cell-based, beam-based (e.g., for FR2), and UE geographic location may all be considered because the usefulness and feasibility of the different granularities of the information depend on the use case, frequency layer, and timescale involved, so tradeoffs exist between the options in terms of accuracy and simplicity.

There currently exist certain challenges. For example, according to existing or published technology, there is an interest to signal between RAN nodes predictions of the trajectory a UE may follow. However, specification impact is not clear. For example, beam-level prediction may be used for configuring target beams, but no details are specified, indicating what beam-level prediction really means and how the information may be used for mobility optimization purposes or any other purpose.

Another problem that emerges from published technology is that some piece of information, such as predicted UE geographical location, may not be available due to missing user consent, thereby strongly limiting the ability to use a predicted UE trajectory based on UE geographical location (or predicted UE geographical location).

### SUMMARY

As described above, certain challenges currently exist with user equipment (UE) history information. Certain aspects of the present disclosure and their embodiments may provide solutions to these or other challenges. For example, in particular embodiments, a first network node in a communication network sends to a second network node (and/or to a third network node) a UE mobility prediction report.

The first network node, prior to sending the UE mobility prediction report to the second network node (and/or to the third network node), may have received from the second network node a request to obtain from the first network node a UE mobility prediction report.

The network node obtaining or deriving the UE mobility prediction report may be the host of an AI/ML Model inference function and/or an AI/ML model training function.

A UE mobility prediction report may be derived based on a UE mobility report requested to a UE and considering conditions, indications, and requests comprised in a UE mobility prediction configuration, where a UE mobility prediction configuration may be at least in part pre-configured, and/or configured at a network node, and/or at least in part obtained from another network node.

In some embodiments, the UE mobility prediction report may be derived from information collected and reported to the first network node by UEs and neighbor radio access network (RAN) nodes or by other systems, such as the operations and management (OAM) system.

A network node may use a UE mobility prediction report for network optimization purposes.

In general, particular embodiments include signaling facilitating one gNB to request from another gNB information needed to run trajectory predictions for a UE, and/or signaling facilitating one gNB to send to another gNB trajectory prediction for a UE at handover preparation.

According to some embodiments, a method performed by a network node comprises deriving a mobility prediction report for a wireless device and transmitting the mobility prediction report to another network node.

In particular embodiments, the method further comprises receiving a mobility report for the wireless device and wherein deriving the mobility prediction report is based at least in part on the received mobility report. The method may further comprise receiving a request for a mobility prediction report and/or receiving a mobility prediction configuration (e.g., from another network node) and wherein deriving the mobility prediction report is further based on the mobility prediction configuration.

In particular embodiments, the mobility prediction configuration comprises an indication of a maximum number of cells or synchronization signal block (SSB) beams to be reported. The mobility prediction configuration may comprise an indication of a maximum number of SSB beams per cell to be reported. The mobility prediction configuration may comprise an indication to include or exclude one or more carrier frequencies. The mobility prediction configuration may comprise an indication of a velocity threshold of the wireless device with respect to a cell or SSB beam for the cell or SSB beam to be included in the mobility prediction report. The mobility prediction configuration may comprise an indication for the mobility prediction report to include one or more of: a weight indicating a probability that a cell or SSB beam will be the one that the wireless device will move toward; and a weight indicating a probability that a cell or SSB beam will be the one that the wireless device will move from. The mobility prediction configuration may comprise an indication for the mobility prediction report to include an expected time the wireless device will spend in coverage of a cell or SSB beam. The mobility prediction configuration may comprise an indication for the mobility prediction report to include cell or SSB beam identifiers, carrier frequencies, or radio access technologies associated with a cell or SSB beam in the mobility prediction report.

In particular embodiments, the mobility prediction report comprises an indication of one or more cells or SSB beams that the wireless device is predicted to traverse, a SSB beam index of one or more SSB beams that the wireless device is predicted to traverse, a Radio Resource Control (RRC) state of the wireless device when entering or leaving the coverage area of a cell or SSB beam, a mobility state of the wireless device when entering or leaving the coverage area of a cell or SSB beam, an identifier of a carrier frequency, band, or radio access technology associated with a cell or SSB beam that the wireless device is predicted to traverse, an expected time the wireless device will spend in coverage of a cell or SSB beam, a velocity of the wireless device associated with a cell or SSB beam that the wireless device is predicted to traverse, a weight indicating a probability that a cell or SSB beam will be the one that the wireless device will move toward, and/or a weight indicating a probability that a cell or SSB beam will be the one that the wireless device will move from.

In particular embodiments, the method further comprises modifying cell coverage based on the mobility prediction report.

According to some embodiments, a method performed by a second network node comprises receiving a mobility prediction report from a first network node and performing network optimization based on the mobility prediction report.

In particular embodiments, the method further comprises transmitting a request for a mobility prediction report to the first network node and/or transmitting a mobility prediction configuration to the first network node.

In particular embodiments, performing network optimization comprises reserving, preparing, or activating radio or transport resources based on the mobility prediction report, modifying cell coverage based on the mobility prediction report, and/or transmitting the mobility prediction report to a third network node.

According to some embodiments, a network node comprises processing circuitry operable to perform any of the network node methods described above.

Another computer program product comprises a non-transitory computer readable medium storing computer readable program code, the computer readable program code operable, when executed by processing circuitry to perform any of the methods performed by the network nodes described above.

Certain embodiments may provide one or more of the following technical advantages. For example, particular embodiments improve mobility performance, e.g., by anticipating to a network node that one or more of its cells or SSB beams are expected to be involved in the mobility for a UE. By knowing in advance the cells or SSB beams that the UE will connect to, the gNB may, e.g., optimize resources, take better energy saving decisions, optimize future handovers by selecting the right cell/frequency, etc. Particular embodiments facilitate the network to dynamically configure such predictions, and request inputs needed to run the predictions, if needed.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 is a block diagram illustrating the next generation radio access network (NG-RAN) architecture;

FIG. 2 is a block diagram illustrating the architecture for separation of gNB-CU-CP and gNB-CU-UP;

FIG. 3 is a block diagram illustrating the functional framework for artificial intelligence (AI)/machine learning (ML) in RAN captured in 3GPP TR 37.817 v17.0.0;

FIG. 4 is a block diagram illustrating an example wireless network;

FIG. 5 illustrates an example user equipment, according to certain embodiments;

FIG. 6 illustrates an example virtualization environment, according to certain embodiments;

FIG. 7 illustrates an example telecommunication network connected via an intermediate network to a host computer, according to certain embodiments;

FIG. 8 illustrates an example host computer communicating via a base station with a user equipment over a partially wireless connection, according to certain embodiments;

FIG. 9 is a flowchart illustrating a method implemented, according to certain embodiments;

FIG. 10 is a flowchart illustrating a method implemented in a communication system, according to certain embodiments;

FIG. 11 is a flowchart illustrating a method implemented in a communication system, according to certain embodiments;

FIG. 12 is a flowchart illustrating a method implemented in a communication system, according to certain embodiments;

FIG. 13 is a flowchart illustrating an example method performed by a network node, according to particular embodiments; and

FIG. 14 is a flowchart illustrating another example method performed by a network node, according to particular embodiments.

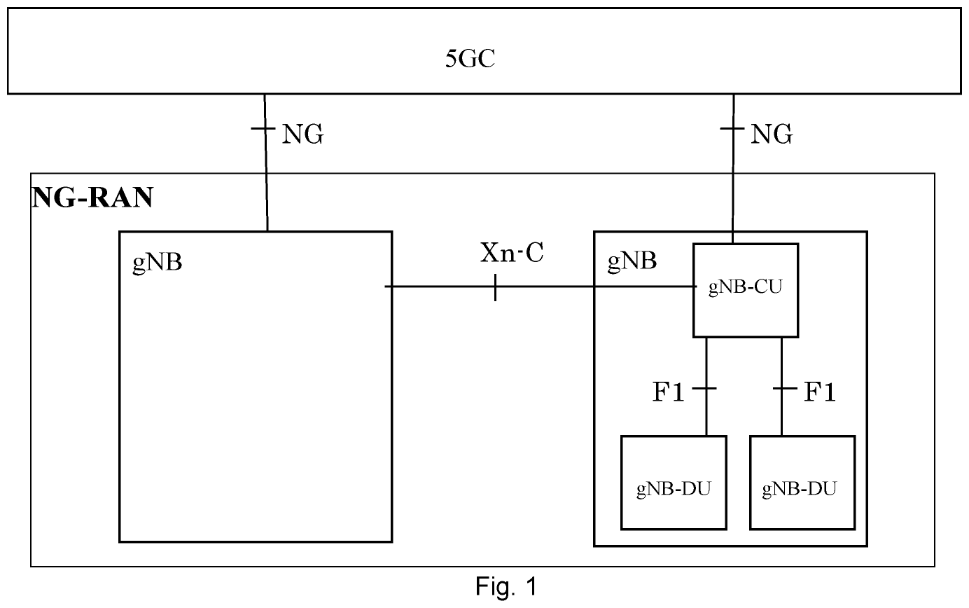

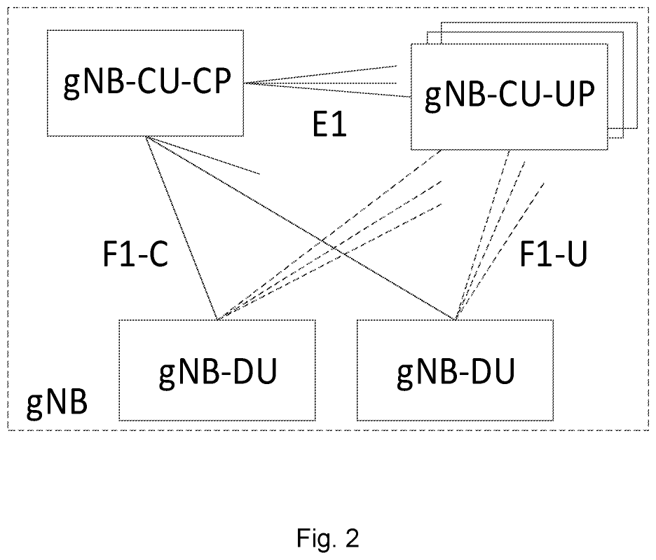

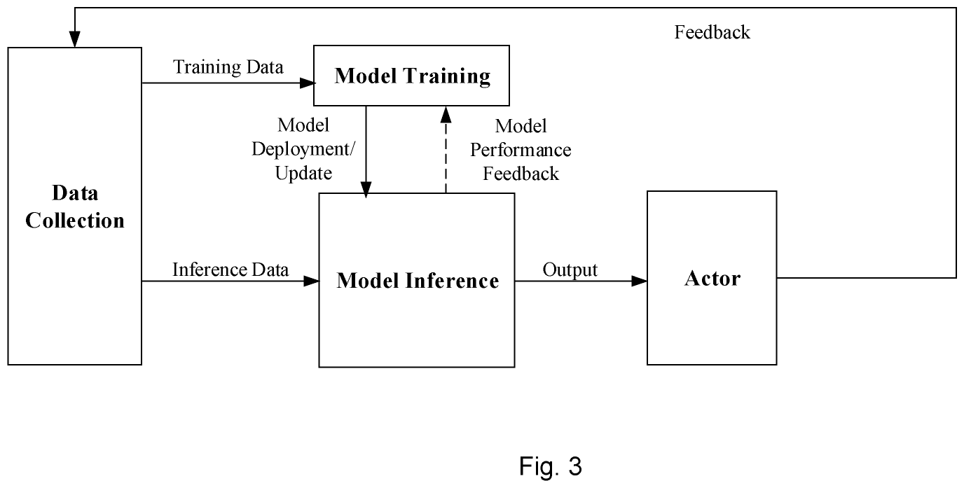

### DETAILED DESCRIPTION

Particular embodiments are described with respect to a network node. A network node may be a radio access network (RAN) node, an operation and management (OAM) node, a Core Network (CN) node, a service management and orchestration (SMO) node, a Network Management System (NMS), a Non-Real Time RAN Intelligent Controller (Non-RT RIC), a Real-Time RAN Intelligent Controller (RT-RIC), a gNB, eNB, en-gNB, ng-eNB, gNB-CU, gNB-CU-CP, gNB-CU-UP, gNB-DU, eNB-CU, eNB-CU-CP, eNB-CU-UP, eNB-DU, integrated access and backhaul (IAB) node, IAB-donor DU, IAB-donor-CU, IAB-DU, IAB-MT, O-CU, O-CU-CP, O-CU-UP, O-DU, O-RU, O-eNB, a cloud-based network function, and/or a cloud-based centralized training node.

In some embodiments, a first network node in a communication network sends to a second network node (and/or to a third network node) a user equipment (UE) mobility prediction report. The UE mobility prediction report may be signaled using legacy procedures (e.g., Handover Preparation or Retrieve UE Context) or using new dedicated procedures.

In some embodiments, the first network node, prior to sending the UE mobility prediction report to the second network node (and/or to a third network node), may have received from the second network node a request to obtain from the first network node a UE mobility prediction report.

A UE mobility prediction report comprises information of cells and/or SSB beams that the UE is predicted to traverse, the content of such report is further described below. In some embodiments, the UE mobility prediction report consists of a list of cells the UE is predicted to traverse, in chronological order (the first predicted cell that the UE will move to after the serving cell is added to the top of this list). For each cell contained in the list, a list of SSB beams belonging to the cell, and that the UE is predicted to traverse, may be added, in chronological order (the first predicted SSB beam that the UE will move to after the serving SSB beam is added to the top of this list). A possible implementation is given at the end of this description, as an example.

The first network node, the second network node, and/or the third network node may use a UE mobility prediction report for network optimization purposes, such as:
1. Reserving/preparing radio and transport resources based on a predicted mobility of the UE towards a specific cell and/or SSB beam.
   a. For a high mobility UE, several network nodes along the expected UE trajectory may start reserving/preparing radio and transport resources to carry out multiple target cell handover preparation, which increases the number of cells prepared as mobility targets and therefore increases the chances that a UE moving into a target cell coverage can be directly handed over to that cell without service interruptions. High mobility UEs might be identified by an estimated high speed and/or estimated short time spent in future cells or SSB beams. Such high mobility estimation may be an extrapolation of past mobility data. It may be achieved by assuming that the UE will follow the mobility trend resulting from past mobility data. Alternatively, such high mobility estimation may be achieved by AI/ML based inference.
   b. If some of the cells and/or SSB beams have been deactivated or reconfigured to reduce the energy consumption, the cells and/or SSB beams may be reactivated or reconfigured before the arrival of the incoming UE and avoid a loss of performance or even coverage for the UE.
   c. In some cases, the trajectory prediction may let the network deduce that it would be optimal if the UE could be served by the same cell during its trajectory path. This may for example be due to the fact that more than one UE is moving at a relatively high speed (where such high mobility state may, for example, be calculated as described above). In such cases, the cost of multiple handovers across many cells and for many UEs may be too expensive in terms of network resources and it may lead to performance degradations. Thus, in light of the trajectory prediction received from other nodes or derived internally one or more of the following may occur. The RAN node serving the UE, assuming it derived or received a trajectory prediction for the UE, modifies its serving and possibly neighbor cell coverage to enable the UE to remain connected to the same cell for as long as possible or to be handed over to as few cells as possible along its predicted trajectory. Such cell coverage modification also implies modification of beams forming the cell. In some embodiments, the serving RAN node may signal to neighbor RAN nodes, ahead of UE mobility to them, the predicted UE trajectory so that such neighbor RAN node may adapt their cell coverage adequately. The RAN node receiving the UE trajectory prediction but not yet serving the UE may adapt its cell and beam coverage to achieve mobility optimization for the one or more UE sharing the predicted UE trajectory.
2. Sending to other network nodes a list of preferred/recommended cells and SSBs to be considered by the second network node for UE mobility. For example, the first network node sends to a third network node a list of cells/beams of the second network node that are expected/predicted to be involved in mobility from the second network node to the third network node.
3. Informing other network nodes that one or more of the predicted cells or SSB beams in the trajectory of the UE are allowed or not allowed to serve the UE.
4. Sending to other network nodes a list with cells that are likely to lead to unsuccessful handover if chosen.
5. Sending to other network nodes a list with cells that can be considered as candidate cells for conditional handover (CHO).
6. Sending to other nodes a list of one or more predicted cells or SSB beams in the trajectory of the UE and in the order the UE would enter them. In some cases, the node sending the prediction may not be aware of the cell or SSB beam the UE will enter after entering a cell and/or beam that is known to the node generating the prediction. In this case, the node generating the prediction may provide one or more of the following information.
   a. A direction identifying the movement of the UE. Such direction may be represented in terms of a bearing angle, where the direction is specified in terms of combinations of North, South, East, West, for example a possible direction indication could be “45 degrees North”. Such direction may be also represented in other terms such as an angle of arrival with respect to a pre-configured zero degree angle. With this information the node receiving the trajectory prediction is able to deduce towards which node or cell the UE will move, despite such node or cells being unknown to the node that produced the prediction and not being included explicitly in the prediction.
   b. For the time where the node generating the prediction is not aware of the cell and/or beam that the UE will enter, the node generating the prediction includes an indication of such time span as well as an indication that the cells and/or beams the UE will go through within such time span are unknown. After such indication, the node generating the prediction may include more cells and/or beams where the UE is predicted to move through, assuming that such information can be inferred. With this information, the node receiving the trajectory prediction is able to deduce towards which node or cells the UE will move, despite such node or cells being unknown to the node that produced the prediction and not being included explicitly in the prediction.

In some embodiments, the first network node, to derive a UE mobility prediction report may use a UE mobility prediction configuration which may be at least in part preconfigured or configured at the first network node or at least in part received in the request from the second network node to obtain the UE mobility prediction report.

The first network node, prior to sending the UE mobility prediction report to the second network node, may have performed one or more of the following steps.
1. Sent to a UE a request to obtain from the UE a UE mobility report comprising information of cells and/or SSB beams traversed by the UE. An example is the UE History Information from the UE reported by the UE in the VisitedCellInfoList contained in the UEInformationResponse message.
2. Received from the UE the UE mobility report. Alternatively, the first network node might have received the UE mobility report from another network node, e.g., along with the UE context.

The first network node may use at least part of a received UE mobility report for deriving a UE mobility prediction report. In one implementation, the UE mobility report may be an extended version of the NR RRC VisitedCellInfoList IE as defined in 3GPP TS 38.331 v17.1.0. In one implementation, the UE mobility prediction report may be an extended version of the UE History Information IE as defined in the 3GPP TS 38.423 v17.1.0.

A UE mobility report may comprise one or more of the following:
1. identifiers of one or more cells (e.g., NR CGI, Physical Cell Identities)
2. identifiers of one or more SSB beams (e.g., SSB beam index)
3. identifiers of carrier frequencies (e.g., ARFCN)
4. identifiers of bands
5. identifiers of Radio Access Technologies
6. coverage levels (e.g., RSRP, RSRQ, SINR) for one or more cells and/or one or more SSB beams
7. timestamps corresponding to the times at which the UE (re) selected a cell
8. timestamps corresponding to the times at which the UE initiated/completed a connection setup a connection towards a cell
9. timestamps corresponding to the times at which the UE initiated/completed a reconfiguration with synch towards the cell
10. the total time the UE spent in the cell or SSB beam
11. indication of the RRC state of the UE (e.g., when entering or when leaving the coverage area of a cell or the coverage area of an SSB beam)
12. the UE measured velocity while being served by a cell or an SSB beam (average, minimum, maximum, percentiles)
13. the UE mobility state while being in the coverage area of a cell or an SSB beam
14. RVQOE measurements collected while the UE was served by the cell, or camped on the cell (for a certain service type(s))

A UE mobility prediction configuration may comprise indications, conditions, and requests that the first network node may use for deriving a UE mobility prediction report, such as one or more of the following:
1. indication to include a validity time (or expiration time) for the report
2. indications to include an uncertainty for the complete report, or per-item included in the report
3. indication of a maximum number N of cells to be reported
4. indication of a maximum number M of SSB beams to be reported
5. indication of a maximum number S of SSB beams per cell to be reported
6. indication to include only the cells whose coverage level (predicted or measured) is stronger than X
7. indication to include only the SSB beams whose coverage level (predicted or measured) is stronger than Y
8. indication to include only the SSB beams of a cell whose coverage level (predicted or measured) is stronger than Z
9. indication to include/exclude one or more carrier frequencies
10. indication to include/exclude one or more radio access technologies (RATs)
11. indication to include/exclude UE velocity
12. indication to include/exclude UE mobility state
13. indication of a threshold indicating a minimum/maximum UE velocity predicted (or measured) in a cell or in SSB beam, for information concerning the cell to be included in the report
14. indication to include/exclude information collected by the UE when the UE is in a specific RRC state (e.g., NR RRC_CONNECTED) while traversing a cell or an SSB beam
15. indication to include/exclude RVQoE measurements
16. request to include for one or more cells one or more of:
   a. cell identifier(s), e.g., NR Cell Global Identity or EUTRA Cell Global Identity
   b. a physical cell identity
   c. a carrier frequency
   d. a RAT
   e. number of measured SSB beams in the cell
   f. coverage level of the cell
   g. information concerning one or more SSB beams (see below)
   h. information of UE velocity while being served by the cell (e.g., average, minimum, maximum, initial velocity when reselecting the cell, initial velocity when the UE is handed over to the cell)
   i. information of UE mobility state while being camped on the cell
   j. expected time the UE will spend in the cell
   k. a cell coverage state, such as an index indicating the coverage configuration of the cell
   l. a weight, e.g., to indicate the probability that a certain cell will be the one towards which the UE will move
   m. a weight, e.g., to indicate the probability that a certain cell will be the one from which the UE will move
17. request to include for one or more SSB beams (within an individual cell or multiple cells) one or more of:
   a. a SSB beam index
   b. identifiers of the cell (e.g., NR Cell Global Identity or EUTRA Cell Global Identity), to which the SSB beam pertains to
   c. the physical cell identity of the cell corresponding to the SSB beam
   d. a SSB coverage state, such as an index indicating the coverage configuration of the SSB beam
   e. a weight, e.g., to indicate the probability that a certain SSB beam will be the one towards which the UE will move
   f. a weight, e.g., to indicate the probability that a certain SSB beam will be the one from which the UE will move
18. request to include weights associated to combinations of cells and/or SSB beams that can be involved in UE mobility. For example: a UE now served by SSB beam 1 of cell A is predicted to move towards SSB beam 2 of cell B with a probability of 40%; the same UE is predicted to move towards SSB beam 3 of cell B with a probability of 60%. In this case, the request to report the weight can produce a response (included in the UE mobility prediction report) of a first weight of 0.4 (or 40%) associated to the combination: (source: (cell A, SSB beam 1), target: (cell B, SSB beam 2)), and a second weight of 0.6 (or 60%) associated to the combination: (source: (cell A, SSB beam 1), target: (cell B, SSB beam 3)).
19. A request to include information only concerning the cells and beams the node generating the prediction is aware of, for example, cells and beams with which the node generating a prediction has a neighbor relation, or whether to include in the prediction also information about the UE trajectory for those time laps where the cells and beams entered by the UE are not known to the node generating the prediction.

The UE mobility prediction report may comprise:
1, at least a part of the UE mobility report (e.g., the identities of the cells or SSB beams traversed by the UE)
2. indication of a validity time
3. indication of uncertainty, for the complete report, or per-item of the report
4. identities of cells the UE is expected to traverse (e.g., reselect or handover to) in a future time interval
5. a cell coverage state, such as an index indicating a current or a predicted coverage configuration for the cell
6. indications of carrier frequencies
7. indications of RATs
8. indications of frequency bands
9. SSB beams index and/or identities of SSB beams the UE is expected to traverse in a future time interval
10. a SSB coverage state, such as an index indicating a current or a predicted coverage configuration for the SSB beam
11. predicted cell coverage (for a target cell, or for a source cell)
12. predicted SSB beam coverage (for a target SSB beam, or for a source SSB beam)
13. predicted coverage levels (e.g., RSRP, RSRQ, SINR) for one or more cells and/or one or more SSB beams
   a. The predicted coverage levels could correspond to the expected average level, median value, maximum or minimum, a confidence interval, certain percentile(s), etc.
   b. The predicted coverage levels may correspond to the whole or part of the time the UE is in the cell or SSB beam, at a certain point in time, etc.
14. prediction of UE velocity and/or UE mobility state for a future time interval, or at reselection of a cell or at handover to a cell.
15. predicted coverage of the source cell at handover preparation
16. predicted coverage of the source cell at handover execution
17. predicted coverage of the target cell at handover preparation
18. predicted coverage of the target cell at handover execution
19. a predicted time interval within which the UE is expected to move towards certain cells/SSB beams, and associated uncertainty (or accuracy)
   a. The time may be an expected value, a median value, maximum and/or minimum (or earliest and/or latest) value, certain percentile(s), etc.
20. weight(s) pertaining to UE mobility.

A weight may be a number. For example, a lower number may indicate a lower probability for a cell to be the one towards which the UE will move. The opposite is also possible (lower number indicating higher probability).

A weight may be obtained as a function of parameters/information comprised in a UE mobility report received from a UE. For example, a weight of a cell may be derived from the reported UE measured velocity when the UE traversed a cell. Or a weight of an SSB may be derived based on the coverage level of the SSB beam measured with the strongest coverage.

A weight may pertain to one of:
a. a cell or a list of cells (measured or predicted) towards which the UE can move. A weight may indicate a ranking (or a priority, or a probability) for the UE to move towards such cells.
b. a cell or a list of cells (measured or predicted) from which the UE can move. A weight may indicate a ranking (or a priority, or a probability) for the UE to move from such cells.
c. an SSB beam or a list of SSB beams (measured or predicted) towards which the UE can move. A weight may indicate a ranking (or a priority, or a probability) for the UE to move towards such SSB beams.
d. an SSB beam or a list of SSB beams (measured or predicted) from which the UE can move. A weight may indicate a ranking (or a priority, or a probability) for the UE to move from such SSB beams.
e. a tuple indicating a combination of cells and/or SSB beams considered for UE mobility. A tuple may comprise parameters pertaining to cells and/or to SSB beams. A weight may indicate a ranking (or a priority, or a probability) that the UE will move between a certain source cell (or a certain combination of source cell and SSB beam of the source cell—the latter, in short “a source SSB beam”) and a certain target cell (or a certain combination of target cell and SSB beam of the target cell—the latter, in short “target SSB beam”). A tuple may refer to more than one target cells and/or one or more target SSB beams, in which case the target cells may be the candidate cells for a conditional handover.
   i. In one variant, a tuple is of type: (source cell, target cell), and comprises: parameters (e.g., an identifier) of a source cell for a handover (or conditional handover), the source cell being one of the cells measured by the UE or a predicted source cell for handover (or conditional handover), and an identifier of a target cell, e.g., a predicted target cell for handover (or conditional handover)
   ii. In another variant, a tuple is of type: (source cell 1, target cell 1, target cell 2, . . . target cell N), and comprises: parameters (e.g., an identifier) of a first cell (source cell 1), the first cell being the source cell for a handover (or a conditional handover), and the source cell being one of the cells measured by the UE or the predicted best cell source cell for a handover (or conditional handover), parameters (e.g., an identifier) of a predicted best target cell (target cell 1) for a handover (or a conditional handover), parameters (e.g., an identifier) of a second-best predicted target cell (target cell 2) for a conditional handover, . . . , parameters (e.g., an identifier) of a predicted Nth-best target cell (target cell N) for a conditional handover. The ranking among multiple predicted source cells (and/or the ranking among multiple predicted target cells) may be determined based on a number of factors. Non-limiting examples include: reported UE measurements, resource status information concerning predicted source cells and target cells, configuration parameters of predicted source cells and target cells, energy saving actions initiated by predicted source cells and/or predicted target cells.
   iii. In another variant, a tuple is of type: (target cell 1, target cell 2, . . . target cell N), and comprise: parameters (e.g., an identifier) of a predicted best target cell (target cell 1) for a handover (or a conditional handover), parameters (e.g., an identifier) of a second-best predicted target cell (target cell 2) for a handover (or a conditional handover), . . . , parameters (e.g., an identifier) of a predicted Nth-best target cell (target cell N) for a handover (or a conditional handover). The ranking among multiple predicted target cells may be determined based on the same criteria as described for a tuple of type “(source cell 1, target cell 1, target cell 2, . . . target cell N)”
   iv. In another variant, a tuple may be of type: (source cell 1, source SSB beam 1, target cell 1), and comprises: parameters (e.g., an identifier) of a source cell (source cell 1) for a handover (or a conditional handover), the source cell being one of the cells measured by the UE or a predicted source cell for handover (or a conditional handover), parameters (e.g., an identifier) of a source SSB beam (source SSB beam 1), e.g. the SSB beam of the source cell with the measured strongest coverage, or the SSB beam of the source cell with the predicted strongest coverage, parameters (e.g., an identifier) of a target cell (target cell 1) for a handover (or conditional handover), the target cell being a predicted target cell for handover
   v. In another variant, a tuple may be of type: (source cell 1, source SSB beam 1, target cell 1, target SSB beam 1, target cell 2, target SSB beam 2, . . . , target cell N, target SSB beam N), and comprises: parameters (e.g., an identifier) of a source cell (source cell 1) for a handover (or a conditional handover), the source cell being one of the cells measured by the UE or a predicted source cell for handover (or a conditional handover), parameters (e.g., an identifier) of a source SSB beam (source SSB beam 1), e.g. the SSB beam of the source cell with the measured strongest coverage, or the SSB beam of the source cell with the predicted strongest coverage, parameters (e.g., an identifier) of a first target cell (target cell 1) for a handover (or conditional handover), the first target cell being a predicted target cell for handover, parameters (e.g., an identifier) of a first target SSB beam (target SSB beam 1), e.g. the SSB beam of the first target cell with the measured strongest coverage, or the SSB beam of the first target cell with the predicted strongest coverage, parameters (e.g., an identifier) of a second . . . , of the Nth target cell (respectively target cell 2 . . . target cell N) for a conditional handover, the second . . . Nth target cell being a predicted target cell for conditional handover, parameters (e.g., an identifier) of a second . . . Nth target SSB (respectively target SSB beam 2, . . . target SSB beam N), e.g. the SSB beam of the second target cell ( . . . the SSB beam of the Nth target cell) with the measured strongest coverage, or the SSB beam of the second target cell ( . . . the SSB beam of the Nth target cell) with the predicted strongest coverage
f. A direction identifying the movement of the UE. Such direction may be represented in terms of a bearing angle, where the direction is specified in terms of combinations of North, South, East, West, for example a possible direction indication could be “45 degrees North”. Such direction may be also represented in other terms such as an angle of arrival with respect to a pre-configured zero degree angle.
g. For the time where the node generating the prediction is not aware of the cell and/or beam that the UE will enter, the node generating the prediction includes an indication of such time span as well as an indication that the cells and/or beams the UE will go through within such time span are unknown. After such indication, the node generating the prediction may include more cells and/or beams where the UE is predicted to move through, assuming that such information can be inferred.
h. A direction in terms of a sequence of geo-coordinates, defining a trajectory the UE will pass through. Such geo-coordinates may for example consist of GPS (GNSS) coordinates or coordinates in other geolocation systems.

A possible example of an implementation of the signaling of the UE mobility prediction report in 3GPP TS 38.423 v17.1.0 is given below.

The HANDOVER REQUEST message is sent by the source NG-RAN node to the target NG-RAN node to request the preparation of resources for a handover.

| | | | | |
|---|---|---|---|---|
| | | | IE type | |
| | | | and | Semantics |
| IE/Group Name | Presence | Range | reference | description |

| | | | |
|---|---|---|---|
| Message Type | M | 9.2.3.1 | |
| Source NG-RAN node | M | NG-RAN | Allocated at |
| UE XnAP ID | | node UE | the source NG- |
| reference | | XnAP ID | RAN node |
| | | 9.2.3.16 | |
| [. . .] | | | |
| 5G ProSe PC5 QoS | O | 9.2.3.160 | This IE applies |
| Parameters | | | only if the UE |
| | | | is authorized |
| | | | for 5G ProSe |
| | | | services. |
| Cell Trajectory | O | 9.2.3.x | |
| Prediction | | | |

| Condition | Explanation |
|---|---|
| ifCHOmod | This IE shall be present if the CHO Trigger |
| | IE is present and set to “CHO-replace”. |

| Range bound | Explanation |
|---|---|
| maxnoofMDTPLMNs | PLMNs in the Management Based MDT |
| | PLMN list. Value is 16. |

The Cell Trajectory Prediction IE contains the list of predicted NR cells the UE will move to after being handed over from the source NG-RAN node.

| | | | IE Type and | |
|---|---|---|---|---|
| IE/Group Name | Presence | Range | Reference | Semantics Description |
| Predicted Trajectory | | 1 . . . | | List of cells where the |
| Cell List | | <maxnoofCellsTrajectoryPredict> | | UE is predicted to |
| | | | | connect, in |
| | | | | chronological order. |
| | | | | The first predicted cell |
| | | | | that the UE will move |
| | | | | to after the serving cell |
| | | | | is added to the top of |
| | | | | this list. |
| >Predicted Trajectory | M | | 9.2.3.y | |
| Cell Information | | | | |

| Range bound | Explanation |
|---|---|
| maxnoofCellsTrajectoryPredict | Maximum number of cells that can be |
| | predicted for UE trajectory. Value is 8. |

The Predicted Trajectory Cell Information contains the cell ID of the predicted cell for trajectory prediction.

| | | | | |
|---|---|---|---|---|
| | | | IE type | |
| | | | and | Semantics |
| IE/Group Name | Presence | Range | reference | description |

| | | |
|---|---|---|
| CHOICE Predicted | M | |
| Trajectory Cell | | |
| Information | | |
| >NG-RAN Cell | | |
| >>Global NG-RAN | M | 9.2.2.3 |
| Node ID | | |

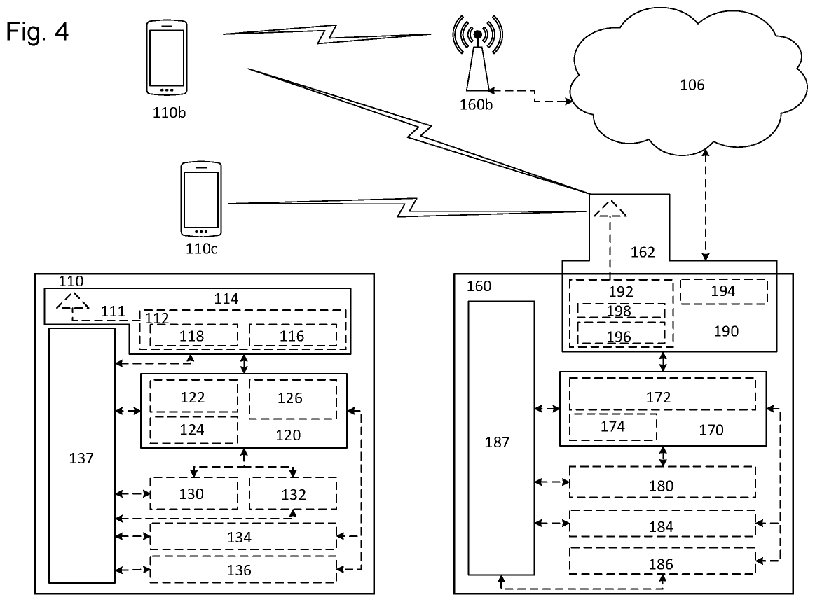

FIG. 4 illustrates an example wireless network, according to certain embodiments. The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and WD 110 comprise various components described in more detail below. These components work together to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network.

Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations.

A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs.

As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 4, network node 160 includes processing circuitry 170, device readable medium 180, interface 190, auxiliary equipment 184, power source 186, power circuitry 187, and antenna 162. Although network node 160 illustrated in the example wireless network of FIG. 4 may represent a device that includes the illustrated combination of hardware components, other embodiments may comprise network nodes with different combinations of components.

It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node.

In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality.

For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units.

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160 but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signaling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162.

Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 192 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160.

For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 4 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air.

In some embodiments, a WD may be configured to transmit and/or receive information without direct human interaction. For instance, a WD may be designed to transmit information to a network on a predetermined schedule, when triggered by an internal or external event, or in response to requests from the network.

Examples of a WD include, but are not limited to, a smart phone, a mobile phone, a cell phone, a voice over IP (VOIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device.

As yet another specific example, in an Internet of Things (IoT) scenario, a WD may represent a machine or other device that performs monitoring and/or measurements and transmits the results of such monitoring and/or measurements to another WD and/or a network node. The WD may in this case be a machine-to-machine (M2M) device, which may in a 3GPP context be referred to as an MTC device. As one example, the WD may be a UE implementing the 3GPP narrow band internet of things (NB-IoT) standard. Examples of such machines or devices are sensors, metering devices such as power meters, industrial machinery, or home or personal appliances (e.g. refrigerators, televisions, etc.) personal wearables (e.g., watches, fitness trackers, etc.).

In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 112 is connected to antenna 111 and processing circuitry 120 and is configured to condition signals communicated between antenna 111 and processing circuitry 120. Radio front end circuitry 112 may be coupled to or a part of antenna 111. In some embodiments, WD 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114.

Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips.

In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner.

In any of those embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110, and/or by end users and the wireless network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen; if WD 110 is a smart meter, the interaction may be through a screen that provides usage (e.g., the number of gallons used) or a speaker that provides an audible alert (e.g., if smoke is detected).

User interface equipment 132 may include input interfaces, devices and circuits, and output interfaces, devices and circuits. User interface equipment 132 is configured to allow input of information into WD 110 and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless network and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry.

Power circuitry 137 may additionally or alternatively be operable to receive power from an external power source; in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

Although the subject matter described herein may be implemented in any appropriate type of system using any suitable components, the embodiments disclosed herein are described in relation to a wireless network, such as the example wireless network illustrated in FIG. 4. For simplicity, the wireless network of FIG. 4 only depicts network 106, network nodes 160 and 160b, and WDs 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. The wireless network may provide communication and other types of services to one or more wireless devices to facilitate the wireless devices' access to and/or use of the services provided by, or via, the wireless network.

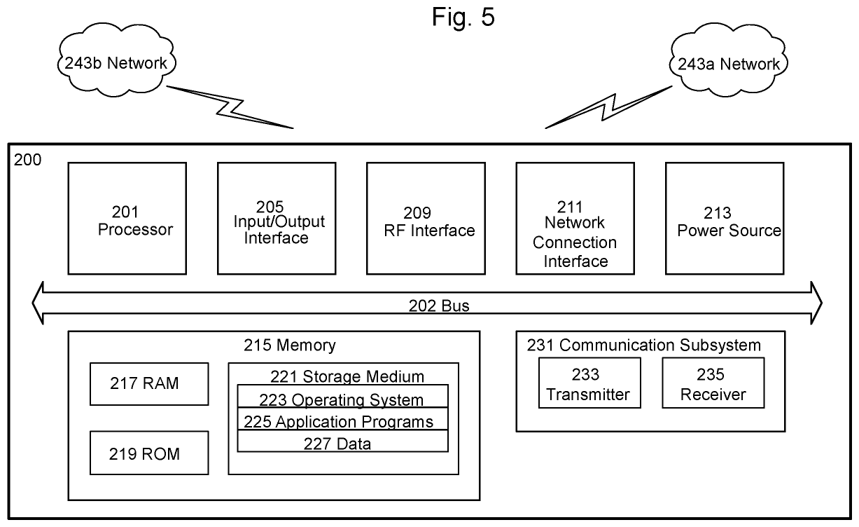

FIG. 5 illustrates an example user equipment, according to certain embodiments. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 200 may be any UE identified by the 3^{rd} Generation Partnership Project (3GPP), including a NB-IoT UE, a machine type communication (MTC) UE, and/or an enhanced MTC (eMTC) UE. UE 200, as illustrated in FIG. 5, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 5 is a UE, the components discussed herein are equally applicable to a WD, and vice-versa.

In FIG. 5, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 213, and/or any other component, or any combination thereof. Storage medium 221 includes operating system 223, application program 225, and data 227. In other embodiments, storage medium 221 may include other similar types of information. Certain UEs may use all the components shown in FIG. 5, or only a subset of the components. The level of integration between the components may vary from one UE to another UE. Further, certain UEs may contain multiple instances of a component, such as multiple processors, memories, transceivers, transmitters, receivers, etc.

In FIG. 5, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205.

An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof.

UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 5, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory.

Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 5, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another WD, UE, or base station of a radio access network (RAN) according to one or more communication protocols, such as IEEE 802.2, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

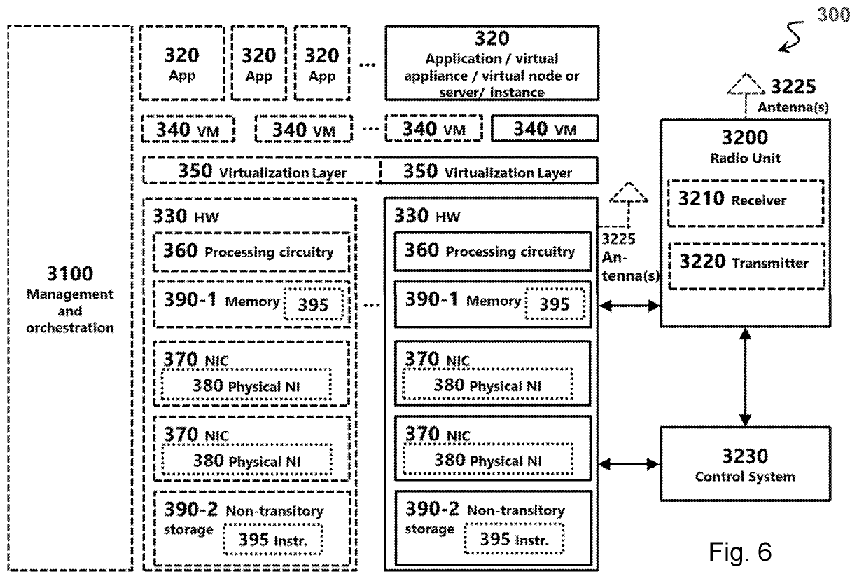

FIG. 6 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 6, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high-volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

Still in the context of NFV, Virtual Network Function (VNF) is responsible for handling specific network functions that run in one or more virtual machines 340 on top of hardware networking infrastructure 330 and corresponds to application 320 in FIG. 18.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signaling can be effected with the use of control system 3230 which may alternatively be used for communication between the hardware nodes 330 and radio units 3200.

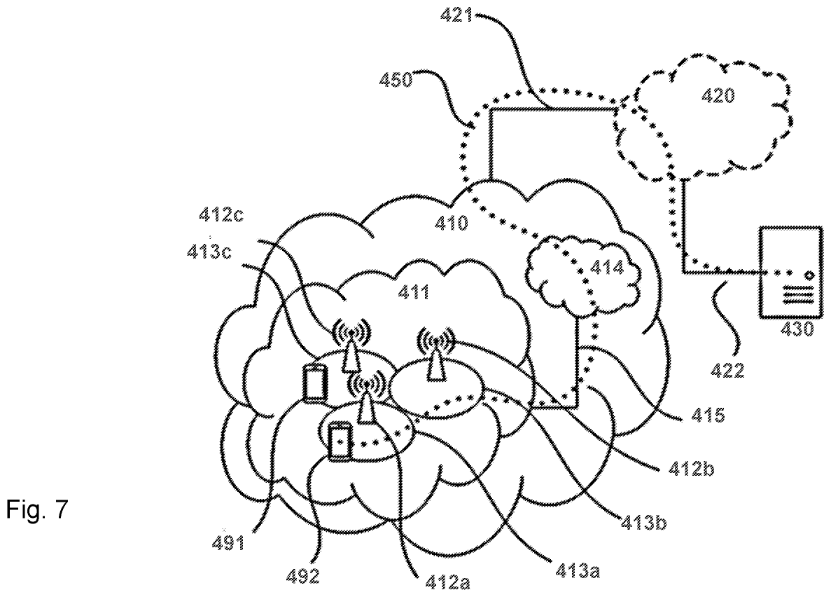

With reference to FIG. 7, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NBs, eNBs, gNBs or other types of wireless access points, each defining a corresponding coverage area 413a, 413b, 413c. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 7 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

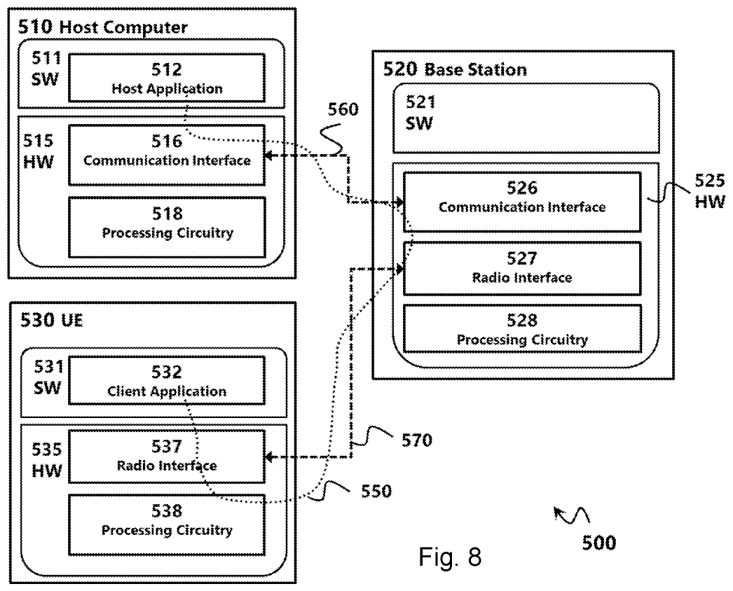

FIG. 8 illustrates an example host computer communicating via a base station with a user equipment over a partially wireless connection, according to certain embodiments. Example implementations, in accordance with an embodiment of the UE, base station and host computer discussed in the preceding paragraphs will now be described with reference to FIG. 8. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 8) served by base station 520. Communication interface 526 may be configured to facilitate connection 560 to host computer 510. Connection 560 may be direct, or it may pass through a core network (not shown in FIG. 8) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 8 may be similar or identical to host computer 430, one of base stations 412a, 412b, 412c and one of UEs 491, 492 of FIG. 4, respectively. This is to say, the inner workings of these entities may be as shown in FIG. 8 and independently, the surrounding network topology may be that of FIG. 4.

In FIG. 8, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., based on load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may improve the signaling overhead and reduce latency, which may provide faster internet access for users.

A measurement procedure may be provided for monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above or supplying values of other physical quantities from which software 511, 531 may compute or estimate the monitored quantities. The reconfiguring of OTT connection 550 may include message format, retransmission settings, preferred routing etc.; the reconfiguring need not affect base station 520, and it may be unknown or imperceptible to base station 520. Such procedures and functionalities may be known and practiced in the art. In certain embodiments, measurements may involve proprietary UE signaling facilitating host computer 510's measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

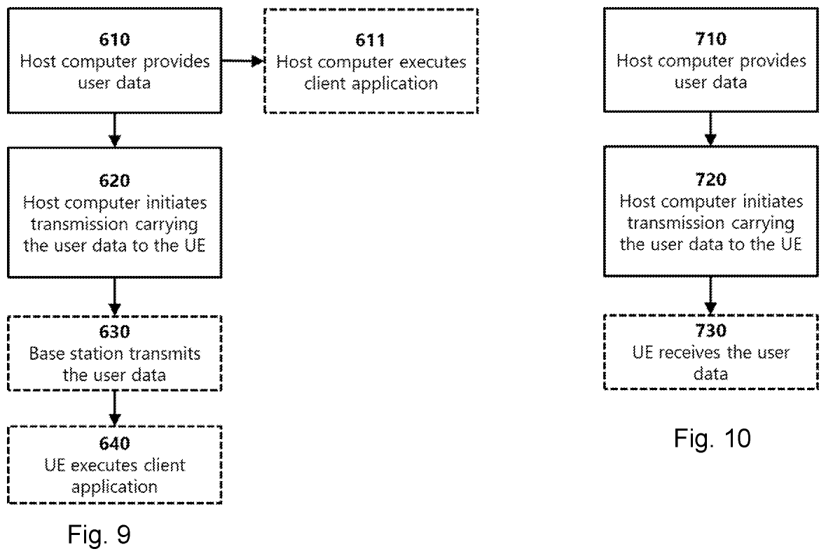

FIG. 9 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 9 will be included in this section.

In step 610, the host computer provides user data. In substep 611 (which may be optional) of step 610, the host computer provides the user data by executing a host application. In step 620, the host computer initiates a transmission carrying the user data to the UE. In step 630 (which may be optional), the base station transmits to the UE the user data which was carried in the transmission that the host computer initiated, in accordance with the teachings of the embodiments described throughout this disclosure. In step 640 (which may also be optional), the UE executes a client application associated with the host application executed by the host computer.

FIG. 10 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 10 will be included in this section.

In step 710 of the method, the host computer provides user data. In an optional substep (not shown) the host computer provides the user data by executing a host application. In step 720, the host computer initiates a transmission carrying the user data to the UE. The transmission may pass via the base station, in accordance with the teachings of the embodiments described throughout this disclosure. In step 730 (which may be optional), the UE receives the user data carried in the transmission.

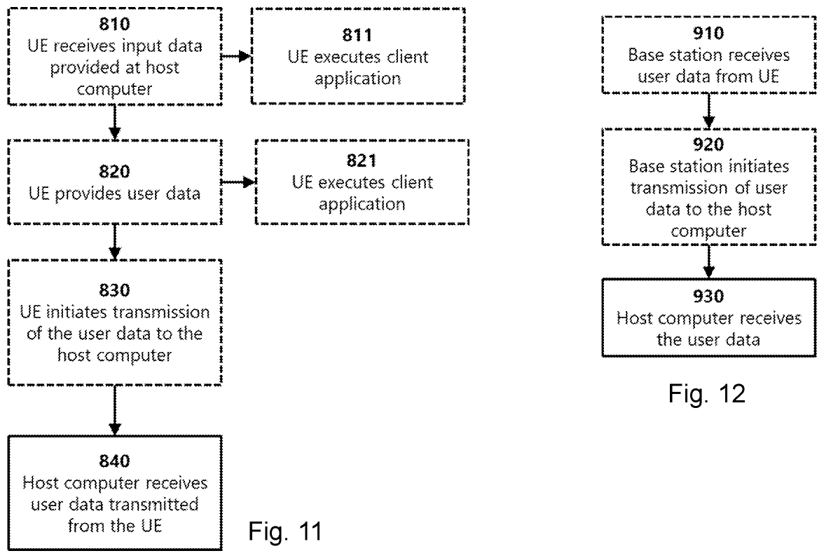

FIG. 11 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 11 will be included in this section.

In step 810 (which may be optional), the UE receives input data provided by the host computer. Additionally, or alternatively, in step 820, the UE provides user data. In substep 821 (which may be optional) of step 820, the UE provides the user data by executing a client application. In substep 811 (which may be optional) of step 810, the UE executes a client application which provides the user data in reaction to the received input data provided by the host computer. In providing the user data, the executed client application may further consider user input received from the user. Regardless of the specific manner in which the user data was provided, the UE initiates, in substep 830 (which may be optional), transmission of the user data to the host computer. In step 840 of the method, the host computer receives the user data transmitted from the UE, in accordance with the teachings of the embodiments described throughout this disclosure.

FIG. 12 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 12 will be included in this section.

In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Modifications, additions, or omissions may be made to the systems and apparatuses disclosed herein without departing from the scope of the invention. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

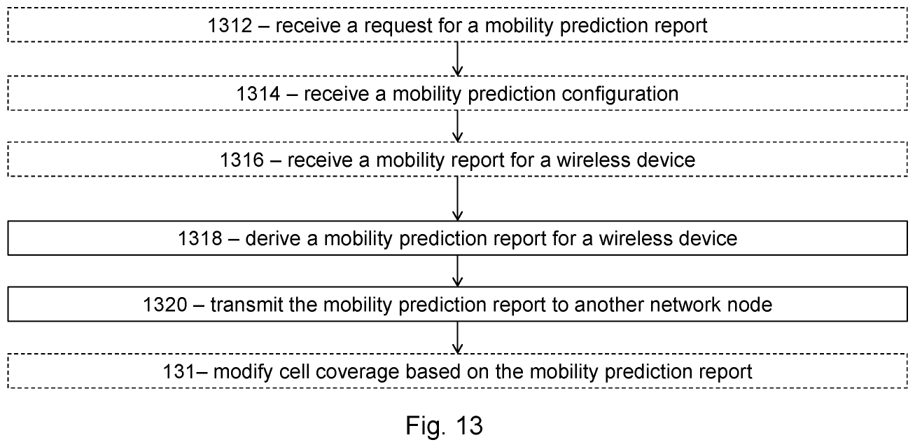

FIG. 13 is a flowchart illustrating an example method performed by a network node, according to particular embodiments. In particular embodiments, one or more steps of FIG. 13 may be performed by network node 160 described with respect to FIG. 4.

The method may begin at step 1312, where the network node (e.g., network node 160) may receive a request for a mobility prediction report. For example, the network node may receive the request from another network node (e.g., network node 160), such as a neighbor network node.

At step 1314, the network node may receive a mobility prediction configuration (e.g., from another network node, such as the neighbor network node). The mobility prediction configuration may indicate to the network node what types of mobility information that the other network node is interested in receiving in the requested mobility prediction report.

In particular embodiments, the mobility prediction configuration comprises an indication of a maximum number of cells or SSB beams to be reported, an indication of a maximum number of SSB beams per cell to be reported, an indication to include or exclude one or more carrier frequencies, an indication of a velocity threshold of the wireless device with respect to a cell or SSB beam for the cell or SSB beam to be included in the mobility prediction report, an indication for the mobility prediction report to include one or more of: a weight indicating a probability that a cell or SSB beam will be the one that the wireless device will move toward, a weight indicating a probability that a cell or SSB beam will be the one that the wireless device will move from, an indication for the mobility prediction report to include an expected time the wireless device will spend in coverage of a cell or SSB beam, and/or an indication for the mobility prediction report to include cell or SSB beam identifiers, carrier frequencies, or radio access technologies associated with a cell or SSB beam in the mobility prediction report. In some embodiments, the mobility prediction configuration includes any of the times described with respect to the embodiments and examples described herein.

In some embodiments, steps 1312 and 1314 may be combined and the request may also include the configuration.

At step 1316, the network node may receive a mobility report for the wireless device. For example, the wireless device may transmit a history of a previous threshold number of cells the wireless device has visited, along with duration, velocity, and other history information. The wireless device may report the history information periodically, based on a triggering event (e.g., handover), or on request from the network node. In other embodiments, the network node may receive a mobility report for the wireless device from another network node or a core network node.

At step 1318, the network node derives a mobility prediction report for a wireless device. The network node may derive the mobility report in response to the request of step 1312, or the network node may derive the mobility report autonomously based on, for example, a triggering condition or event. The network node may derive the mobility prediction report based on the wireless device history report received in the previous step, or based on any other or additional information about prior movement of the wireless device.

In some embodiments, the network node may derive the mobility prediction report using an AI/ML model. In some embodiments, the network node may derive the mobility prediction report according to any of the embodiments and examples described herein.

In particular embodiments, the mobility prediction report comprises an indication of one or more cells or SSB beams that the wireless device is predicted to traverse, a SSB beam index of one or more SSB beams that the wireless device is predicted to traverse, a Radio Resource Control (RRC) state of the wireless device when entering or leaving the coverage area of a cell or SSB beam, a mobility state of the wireless device when entering or leaving the coverage area of a cell or SSB beam, an identifier of a carrier frequency, band, or radio access technology associated with a cell or SSB beam that the wireless device is predicted to traverse, an expected time the wireless device will spend in coverage of a cell or SSB beam, a velocity of the wireless device associated with a cell or SSB beam that the wireless device is predicted to traverse, a weight indicating a probability that a cell or SSB beam will be the one that the wireless device will move toward, and/or a weight indicating a probability that a cell or SSB beam will be the one that the wireless device will move from. In some embodiments, the mobility prediction report comprises any of the information described with respect to the embodiments and examples described herein.

At step 1320, the network node transmits the mobility prediction report to another network node. For example, the network node may transmit the mobility prediction to a requesting network node, such as the requesting network node from optional step 1312, and/or the network node may transmit the mobility prediction report to other network nodes, such as network nodes impacted by the mobility prediction report (e.g., network nodes the wireless device may interact with in the future).

The method may include step 1322, where the network node may modify cell coverage based on the mobility prediction report. For example, based on the mobility prediction report, the network node may modify the shape of cell coverage to increase or decrease the time the wireless device may spend in the cell.

Modifications, additions, or omissions may be made to method 1300 of FIG. 13. Additionally, one or more steps in the method of FIG. 13 may be performed in parallel or in any suitable order.

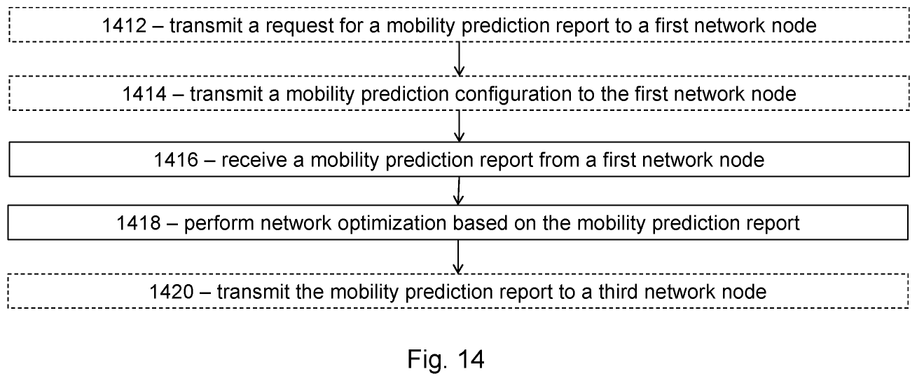

FIG. 14 is a flowchart illustrating another example method performed by a network node, according to particular embodiments. In particular embodiments, one or more steps of FIG. 14 may be performed by network node 160 described with respect to FIG. 4.

The method may begin at step 1412, where a second network node (e.g., network node 160) may transmit a request for a mobility prediction report to a first network node. The request is described in more detail with respect to step 1312 of FIG. 13.

At step 1414, the second network node may transmit a mobility prediction configuration to the first network node. The configuration is described in more detail with respect to step 1314 of FIG. 13.

At step 1416, the second network node receives a mobility prediction report from the first network node. The mobility prediction report is described in more detail with respect to step 1318 of FIG. 13. The second network node may receive the mobility prediction report based on a specific request (e.g., from step 1412), or may autonomously receive the mobility prediction report based on a condition or event.

At step 1418, the second network node performs network optimization based on the mobility prediction report. In particular embodiments, performing network optimization comprises reserving, preparing, or activating radio or transport resources based on the mobility prediction report, and/or modifying cell coverage based on the mobility prediction report.

At step 1420, the second network node may transmit the mobility prediction report to a third network node. For example, the second network node may transmit the mobility prediction report to another network node referred to in the mobility prediction report.

Modifications, additions, or omissions may be made to method 1400 of FIG. 14. Additionally, one or more steps in the method of FIG. 14 may be performed in parallel or in any suitable order.

Modifications, additions, or omissions may be made to the methods disclosed herein without departing from the scope of the invention. The methods may include more, fewer, or other steps. Additionally, steps may be performed in any suitable order.

The foregoing description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

### EXAMPLE EMBODIMENTS

### Group A Embodiments

1. A method performed by a wireless device, the method comprising:
   tracking history information for the wireless device;
   generating a mobility report based on the history information; and
   transmitting a mobility report to a network node.
2. A method performed by a wireless device, the method comprising:
   any of the wireless device steps, features, or functions described above, either alone or in combination with other steps, features, or functions described above.
3. The method of the previous embodiment, further comprising one or more additional wireless device steps, features or functions described above.
4. The method of any of the previous embodiments, further comprising:
   providing user data; and
   forwarding the user data to a host computer via the transmission to the base station.

### Group B Embodiments

5. A method performed by a base station, the method comprising:
   receiving a mobility report from a wireless device;
   deriving a mobility prediction report for the wireless device based at least in part on the received mobility report; and
   transmitting the mobility prediction report to another network node.
6. The method of embodiment 5, further comprising receiving a request for a mobility prediction report.
7. The method of any one of embodiments 5-6, further comprising receiving a mobility prediction configuration and wherein deriving the mobility prediction report is further based on the mobility prediction configuration.
8. The method of any one of embodiments 5-7, wherein the mobility report comprises any of the information described with respect to examples 1-14 described above.
9. The method of any one of embodiment 7, wherein the mobility prediction configuration comprises any of the information described with respect to examples 1-19 described above.
10. The method of any one of embodiments 5-9, wherein the mobility prediction report comprises any of the information described with respect to examples 1-20 described above.
11. A method performed by a base station, the method comprising:
   receiving a mobility prediction report from another network node; and
   performing network optimization based on the mobility prediction report.

12. A method performed by a base station, the method comprising:
a. any of the base station steps, features, or functions described above, either alone or in combination with other steps, features, or functions described above.

13. The method of the previous embodiments, further comprising one or more additional base station steps, features or functions described above.

14. The method of any of the previous embodiments, further comprising:
obtaining user data; and
forwarding the user data to a host computer or a wireless device.

### Group C Embodiments

15. A wireless device, the wireless device comprising:
   processing circuitry configured to perform any of the steps of any of the Group A embodiments; and
   power supply circuitry configured to supply power to the wireless device.
16. A base station, the base station comprising:
   processing circuitry configured to perform any of the steps of any of the Group B embodiments;
   power supply circuitry configured to supply power to the base station.
17. A user equipment (UE), the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
18. A computer program, the computer program comprising instructions which when executed on a computer perform any of the steps of any of the Group A embodiments.
19. A computer program product comprising a computer program, the computer program comprising instructions which when executed on a computer perform any of the steps of any of the Group A embodiments.
20. A non-transitory computer-readable storage medium or carrier comprising a computer program, the computer program comprising instructions which when executed on a computer perform any of the steps of any of the Group A embodiments.
21. A computer program, the computer program comprising instructions which when executed on a computer perform any of the steps of any of the Group B embodiments.
22. A computer program product comprising a computer program, the computer program comprising instructions which when executed on a computer perform any of the steps of any of the Group B embodiments.
23. A non-transitory computer-readable storage medium or carrier comprising a computer program, the computer program comprising instructions which when executed on a computer perform any of the steps of any of the Group B embodiments.
24. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform any of the steps of any of the Group B embodiments.
25. The communication system of the pervious embodiment further including the base station.
26. The communication system of the previous 2 embodiments, further including the UE, wherein the UE is configured to communicate with the base station.
27. The communication system of the previous 3 embodiments, wherein:
   the processing circuitry of the host computer is configured to execute a host application, thereby providing the user data; and
   the UE comprises processing circuitry configured to execute a client application associated with the host application.
28. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs any of the steps of any of the Group B embodiments.
29. The method of the previous embodiment, further comprising, at the base station, transmitting the user data.
30. The method of the previous 2 embodiments, wherein the user data is provided at the host computer by executing a host application, the method further comprising, at the UE, executing a client application associated with the host application.
31. A user equipment (UE) configured to communicate with a base station, the UE comprising a radio interface and processing circuitry configured to performs the of the previous 3 embodiments.
32. A communication system including a host computer comprising:
   processing circuitry configured to provide user data; and
   a communication interface configured to forward user data to a cellular network for transmission to a user equipment (UE),
   wherein the UE comprises a radio interface and processing circuitry, the UE's components configured to perform any of the steps of any of the Group A embodiments.
33. The communication system of the previous embodiment, wherein the cellular network further includes a base station configured to communicate with the UE.
34. The communication system of the previous 2 embodiments, wherein:
   the processing circuitry of the host computer is configured to execute a host application, thereby providing the user data; and
   the UE's processing circuitry is configured to execute a client application associated with the host application.
35. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs any of the steps of any of the Group A embodiments.
36. The method of the previous embodiment, further comprising at the UE, receiving the user data from the base station.
37. A communication system including a host computer comprising:
   communication interface configured to receive user data originating from a transmission from a user equipment (UE) to a base station,
   wherein the UE comprises a radio interface and processing circuitry, the UE's processing circuitry configured to perform any of the steps of any of the Group A embodiments.
38. The communication system of the previous embodiment, further including the UE.
39. The communication system of the previous 2 embodiments, further including the base station, wherein the base station comprises a radio interface configured to communicate with the UE and a communication interface configured to forward to the host computer the user data carried by a transmission from the UE to the base station.
40. The communication system of the previous 3 embodiments, wherein:
   the processing circuitry of the host computer is configured to execute a host application; and
   the UE's processing circuitry is configured to execute a client application associated with the host application, thereby providing the user data.
41. The communication system of the previous 4 embodiments, wherein:
   the processing circuitry of the host computer is configured to execute a host application, thereby providing request data; and
   the UE's processing circuitry is configured to execute a client application associated with the host application, thereby providing the user data in response to the request data.
42. A method implemented in a communication system including a host computer, a base station and a user equipment (UE), the method comprising:
   at the host computer, receiving user data transmitted to the base station from the UE, wherein the UE performs any of the steps of any of the Group A embodiments.
43. The method of the previous embodiment, further comprising, at the UE, providing the user data to the base station.
44. The method of the previous 2 embodiments, further comprising:
   at the UE, executing a client application, thereby providing the user data to be transmitted; and
   at the host computer, executing a host application associated with the client application.
45. The method of the previous 3 embodiments, further comprising:
   at the UE, executing a client application; and
   at the UE, receiving input data to the client application, the input data being provided at the host computer by executing a host application associated with the client application,
   wherein the user data to be transmitted is provided by the client application in response to the input data.
46. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
47. The communication system of the previous embodiment further including the base station.
48. The communication system of the previous 2 embodiments, further including the UE, wherein the UE is configured to communicate with the base station.
49. The communication system of the previous 3 embodiments, wherein:
   the processing circuitry of the host computer is configured to execute a host application;
   the UE is configured to execute a client application associated with the host application, thereby providing the user data to be received by the host computer.
50. A method implemented in a communication system including a host computer, a base station and a user equipment (UE), the method comprising:
   at the host computer, receiving, from the base station, user data originating from a transmission which the base station has received from the UE, wherein the UE performs any of the steps of any of the Group A embodiments.
51. The method of the previous embodiment, further comprising at the base station, receiving the user data from the UE.
52. The method of the previous 2 embodiments, further comprising at the base station, initiating a transmission of the received user data to the host computer.

1. A method performed by a network node, the method comprising:
deriving a mobility prediction report for a wireless device; and
transmitting the mobility prediction report to another network node.

2. The method of claim 1, further comprising receiving a mobility report for the wireless device, wherein
deriving the mobility prediction report comprises deriving the mobility prediction report based at least in part on the received mobility report.

3. (canceled)

4. The method of claim 1, further comprising receiving a mobility prediction configuration and wherein deriving the mobility prediction report is further based on the mobility prediction configuration.

5. The method of claim 4, wherein
the mobility prediction configuration comprises an indication of a maximum number of cells or synchronization signal block (SSB) beams to be reported, and/or
the mobility prediction configuration comprises an indication of a maximum number of synchronization signal block (SSB) beams per cell to be reported.

6-7. (canceled)

8. The method of claim 4, wherein the mobility prediction configuration comprises an indication of a velocity threshold of the wireless device with respect to a cell or synchronization signal block (SSB) beam for the cell or SSB beam to be included in the mobility prediction report.

9. The method of claim 4, wherein the mobility prediction configuration comprises an indication for the mobility prediction report to include:
a weight indicating a probability that a cell or synchronization signal block (SSB) beam will be the one that the wireless device will move toward;
a weight indicating a probability that a cell or SSB beam will be the one that the wireless device will move from;
cell or synchronization signal block (SSB) beam identifiers, carrier frequencies, or radio access technologies associated with a cell or SSB beam in the mobility prediction report; and/or
an expected time the wireless device will spend in coverage of a cell or synchronization signal block (SSB) beam.

10-11. (canceled)

12. The method of claim 1, wherein the mobility prediction report comprises:
an indication of one or more cells or synchronization signal block (SSB) beams that the wireless device is predicted to traverse; and/or
a synchronization signal block (SSB) beam index of one or more SSB beams that the wireless device is predicted to traverse.

13. (canceled)

14. The method of claim 1, wherein the mobility prediction report comprises a Radio Resource Control (RRC) state of the wireless device when entering or leaving the coverage area of a cell or SSB beam.

15. The method of claim 1, wherein the mobility prediction report comprises a mobility state of the wireless device when entering or leaving the coverage area of a cell or synchronization signal block (SSB) beam.

16. The method of claim 1, wherein the mobility prediction report comprises:
an identifier of a carrier frequency, band, or radio access technology associated with a cell or synchronization signal block (SSB) beam that the wireless device is predicted to traverse;
an expected time the wireless device will spend in coverage of a cell or SSB beam; and/or
a velocity of the wireless device associated with a cell or SSB beam that the wireless device is predicted to traverse.

17. The method of claim 1, wherein the mobility prediction report comprises:
a weight indicating a probability that a cell or synchronization signal block (SSB) beam will be the one that the wireless device will move toward; and/or
a weight indicating a probability that a cell or SSB beam will be the one that the wireless device will move from.

18. The method of claim 1, further comprising modifying cell coverage based on the mobility prediction report.

19-20. (canceled)

21. A network node comprising processing circuitry operable to:
derive a mobility prediction report for a wireless device; and
transmit the mobility prediction report to another network node.

22. (canceled)

23. A method performed by a second network node, the method comprising:
receiving a mobility prediction report from a first network node; and
performing network optimization based on the mobility prediction report.

24. The method of claim 23, further comprising transmitting a request for a mobility prediction report to the first network node.

25. The method of claim 23, further comprising transmitting a mobility prediction configuration to the first network node.

26. The method of claim 23, wherein performing network optimization comprises reserving, preparing, or activating radio or transport resources based on the mobility prediction report.

27. The method of claim 23, wherein performing network optimization comprises modifying cell coverage based on the mobility prediction report.

28. The method of claim 23, wherein performing network optimization comprises transmitting the mobility prediction report to a third network node.

29-30. (canceled)

31. A second network node comprising processing circuitry operable to:
receive a mobility prediction report from a first network node; and
perform network optimization based on the mobility prediction report.

32. (canceled)
